(19) United States
(12) Patent Application Publication
(10) Pub. No.: US 2015/0363397 A1
(43) Pub. Date: Dec. 17, 2015

(54) SYSTEMS AND METHODS FOR CONTENT ON-BOARDING

(71) Applicant: Thomson Reuters Global Resources (TRGR), Switzerland (IE)

(72) Inventors: Timothy Nixon, Walchwil (CH); Hassan Malik, Monmouth Junction, NJ (US); Olof-Ors Mans, Zug (CH)

(21) Appl. No.: 14/302,002

(22) Filed: Jun. 11, 2014

(51) Int. Cl. G06F 17/30

(52) U.S. Cl. CPC G06F 17/30011; G06F 17/3053; G06F 17/30867

(57) ABSTRACT

The present disclosure is directed towards systems and methods for generating a recommendation to on-board a candidate document to an on-line research system, which comprises receiving from an electronic device, a set of data items associated with a candidate document, the candidate document being a document that is a candidate to be made available via the on-line research system and storing the set of data items in a memory. The systems and methods of the present disclosure then automatically analyze the set of data items using a computer program stored in the memory and generate a recommendation as to whether to obtain or not obtain the candidate document. A signal is then generated and transmitted to the electronic device, the signal based upon the recommendation.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to this document: Copyright © 2014 Thomson Reuters.

### TECHNICAL FIELD

This disclosure relates generally to the collection of content. More specifically, the disclosure is directed towards systems and methods for recommending the uploading, also referred to as on-boarding, of candidate documents to an on-line research system.

### BACKGROUND

On-line research systems are invaluable tools that are used in nearly every business, legal, scientific and academic environment. For example, in the legal environment, on-line research systems are continually used by attorneys, court personnel and students in order to continuously research and be kept informed of the most recent legal decisions, statutes and legislation. Indeed, it is not uncommon for a judicial decision issued as recently as the previous day to have a substantial impact on an attorney's strategy or a court's legal analysis. Further, it is not uncommon for a judicial decision from a lower court or a different jurisdiction to also have an impact on an attorney's strategy or a court's legal analysis.

Yet, the current methodology employed to upload or on-board documents to an on-line legal research system typically involves a manual process in which an individual, such as a legal runner in a courthouse or a legal sitter monitoring court databases, makes a subjective determination as to whether a candidate document is relevant and should be on-boarded to the on-line legal research system The risk in using such a methodology is that certain court documents, which may be of great importance to a legal analysis, may never actually be captured and included in the on-line legal research system because the legal runner or sitter did not deem the court document as a relevant document that should be uploaded. Furthermore, by employing this methodology, the candidate court document may be lost forever, despite a change in circumstances or user requirements that may greatly increase the importance and relevancy of the candidate document. These risks are especially prevalent when looking to court documents from lower courts or unpopular jurisdictions, where this manual process is employed more often to result in the candidate document not being on-boarded. One theoretical “solution” to this issue is to simply on-board all documents, including for example, small claim court decisions, local building code, and the like. Yet such a “solution” is simply not economically feasible given the high potential cost of on-boarding all documents.

Furthermore, the current methodology employed to on-board documents where court runners are tasked to make the subjective determination as to whether a candidate document is relevant and should be on-boarded to the on-line legal research system creates an issue of inconsistency across the universe of documents that are on-boarded.

Accordingly, there exists a need for automated methods and systems that will make a subjective determination in a quick and efficient manner as to whether a candidate document should be on-boarded to the on-line legal research system. Further there exists a need for automated methods and systems that will continuously evaluate whether a candidate document should be on-boarded to the on-line legal research system in view of future events or statistics demonstrating a need for the candidate document.

### SUMMARY

The present disclosure is directed towards systems and methods recommending the on-boarding of candidate documents to an on-line research system. In one aspect, the method includes receiving, from an electronic device, a set of data items associated with a candidate document, the candidate document being a document that is a candidate to be made available via the on-line research system and storing the set of data items in a first memory. The set of data items are then automatically analyzed using a computer program stored in the first memory and a recommendation as to whether to obtain or not obtain the candidate document is generated using the computer program. A signal is then generated based upon the recommendation and transmitted to the electronic device.

According to one embodiment, the method further includes, in response to the step of transmitting the signal and wherein the recommendation is an obtain recommendation, receiving an electronic version of the candidate document from the electronic device and storing the electronic version in a second memory.

In one embodiment, the method further includes, in response to the step of transmitting the recommendation and wherein the recommendation is a do not obtain recommendation, reviewing the set of data items based upon a set of additional information and determining whether to generate a modified recommendation. If a modified recommendation is generated, the method further includes storing the modified recommendation in the first memory, generating a modified signal based upon the modified recommendation and transmitting the modified signal to the electronic device. According to one embodiment, the step of reviewing is ongoing and is triggered by at least one of an event and an end of a time period since the last time the step of reviewing was performed. In one embodiment, the method further includes, in response to the step of transmitting the modified signal and wherein the modified recommendation is an obtain recommendation, receiving an electronic version of the candidate document from the electronic device and storing the electronic version in the second memory.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for generating a recommendation to on-board a candidate document to an on-line research system;

FIG. 2 is a flow diagram illustrating an exemplary computer-implemented method for generating a recommendation to on-board a candidate document to an on-line research system;

FIG. 3 is a flow diagram illustrating an exemplary computer-implemented method for on-boarding a candidate document to an on-line research system;

FIG. 4 is a flow diagram illustrating an exemplary computer-implemented method for generating a modified recommendation to an on-line research system during a subsequent review;

FIG. 5 is a flow diagram illustrating a further detailed exemplary computer-implemented method for generating a recommendation to on-board a candidate document to an on-line research system; and

FIGS. 6 and 6A are flow diagrams illustrating a further detailed exemplary computer-implemented method for generating a modified recommendation to an on-line research system during a subsequent review.

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure.

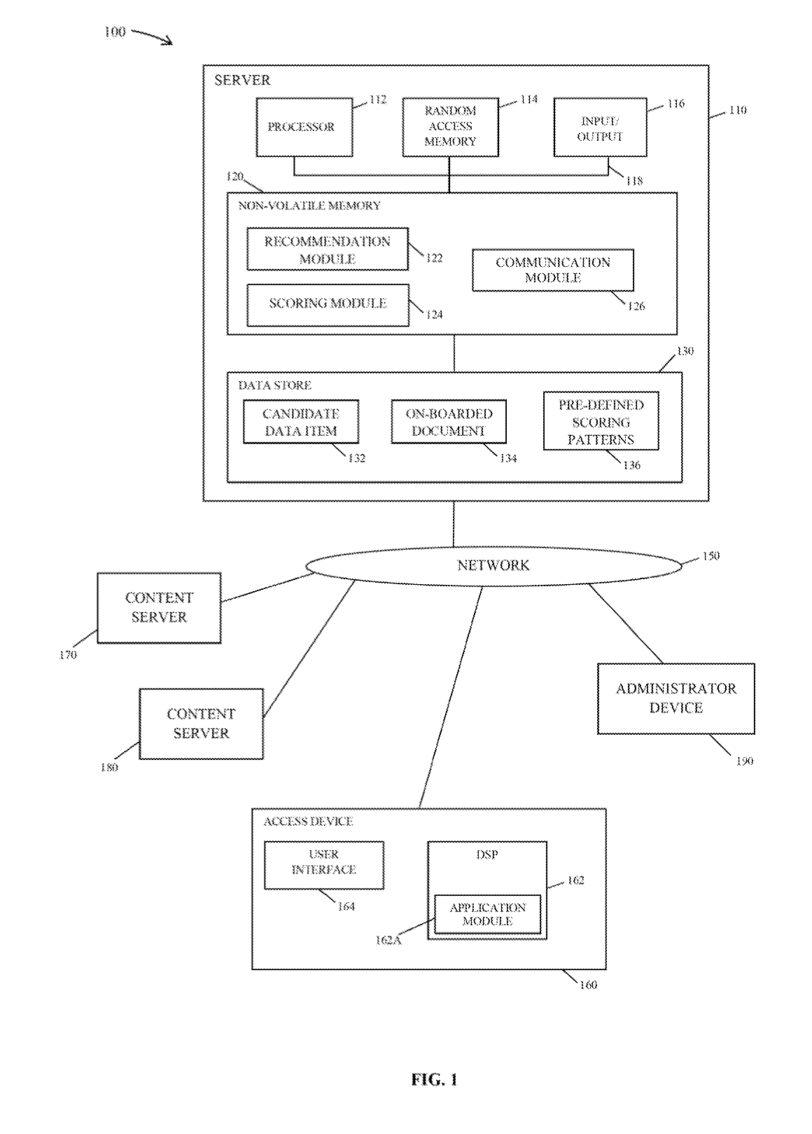

Turning now to FIG. 1, an example of a suitable computing system 100 within which embodiments of the disclosure may be implemented is presented. The computing system 100 is only one example and is not intended to suggest any limitation as to the scope of use or functionality of the disclosure. Neither should the computing system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, and other computer instruction known to those skilled in the art that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which may be written on any form of a computer readable media.

In one embodiment, with reference to FIG. 1, the computing system 100 includes a server device 110 configured to include a processor 112, such as a central processing unit (“CPU”), random access memory (“RAM”) 114, one or more input-output devices 116, such as a display device (not shown) and keyboard (not shown), non-volatile memory 120, all of which are interconnected via a common bus 118 and controlled by the processor 112. According to one embodiment, the server 110 is part of an on-line research system. In another embodiment, the server 110 is separate from the on-line research system and transmits one or more candidate documents to be stored within the on-line research system.

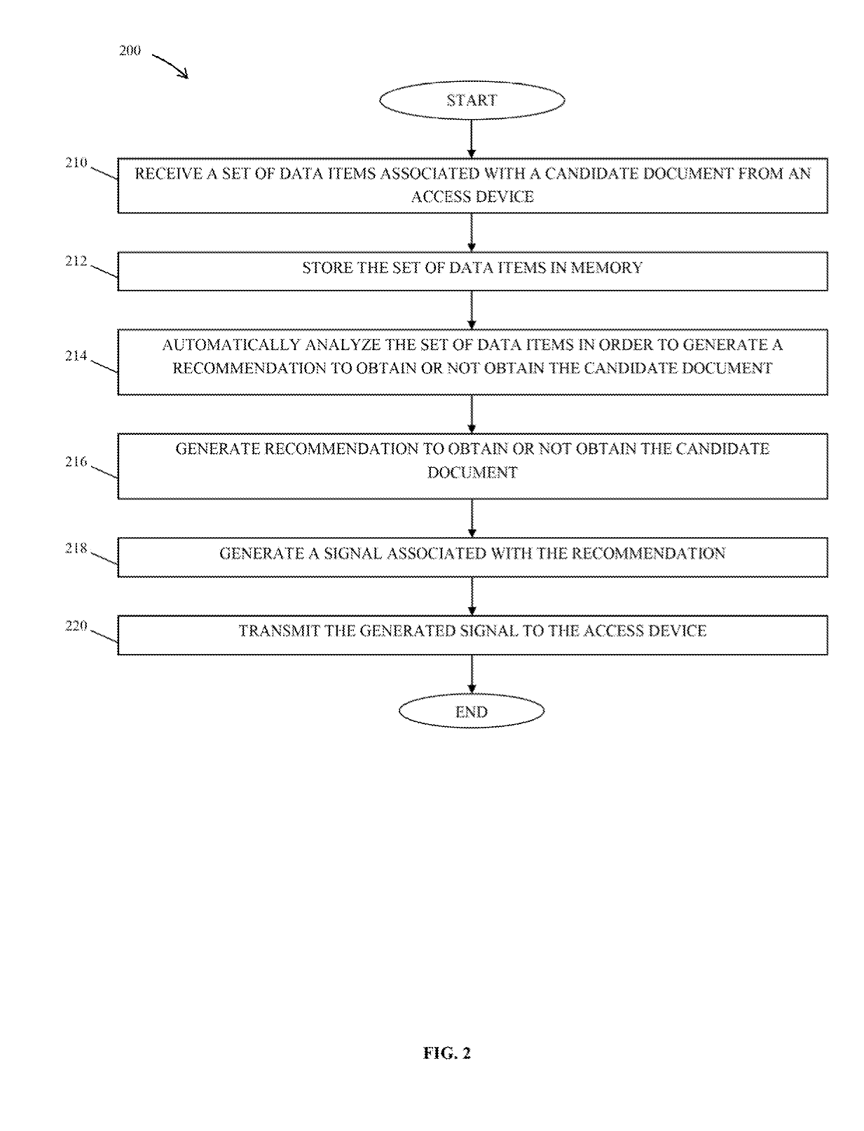

As shown in the FIG. 1 example, in one embodiment, the non-volatile memory 120 is configured to include a recommendation module 122, a scoring module 124 and a communication module 126. The scoring module 124 is configured to analyze one or more data items associated with a candidate document on an iterative basis and generate a score for each of the data items using one or more of the rules maintained in a set of predefined scoring patterns 136, as well as a combined overall score for the candidate document using the individual data item scores. The recommendation module 122 is configured to generate a recommendation to obtain or to not obtain a candidate document, using one or more of the rules maintained in the set of predefined scoring patterns 136 and the scores generated by the scoring module 124. Lastly, a communication module 126 is provided to receive the set of data items associated with the candidate document, as well as any additional information related to the set of data items, and to generate and transmit a signal associated with a recommendation to obtain or not obtain the candidate document. Additional details of modules 122, 124 and 126 are discussed in connection with FIGS. 2-5.

As shown in FIG. 1, in one embodiment, a network 150 is provided that can include various devices such as routers, server, and switching elements connected in an Intranet, Extranet or Internet configuration. In one embodiment, the network 150 uses wired communications to transfer information between an access device 160, the server device 110, a data store 130 and content servers 170 and 180. In another embodiment, the network 150 employs wireless communication protocols to transfer information between the access device 160, the server device 110, the data store 130 and the content servers 170 and 180. For example, the network 150 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 150 may also be a Wide Area Network (WAN), such as the Internet, which employs one or more transmission protocols, e.g. TCP/IP. As another example, the network 150 may employ a combination of digital cellular standards and transmission protocols. In yet other embodiments, the network 150 may employ a combination of wired and wireless technologies to transfer information between the access device 160, the server device 110, the data store 130 and the content servers 170 and 180.

The data store 130 is a repository that maintains and stores information utilized by the before-mentioned modules 122, 124 and 126. In one embodiment, the data store 130 is a relational database. In another embodiment, the data store 130 is a directory server, such as a Lightweight Directory Access Protocol (“LDAP”). In yet another embodiment, the data store 130 is an area of non-volatile memory 120 of the server device 110.

In one embodiment, as shown in the FIG. 1 example, the data store 130 includes a candidate data item database 132, an on-boarded document database 134 and the set of predefined scoring patterns 136. According to one embodiment, the on-boarded document database 134 maintains the electronic versions of the on-boarded documents, i.e. candidate documents that have been uploaded, or on-boarded, from the access device 160. Examples of on-boarded documents include, but are not limited to, court documents, such as judicial decisions, orders and opinions, complaints, answers, briefs, legal memorandum, expert reports, deposition transcripts, trial transcripts, hearing transcripts and party contentions, as well as state and federal statutes, administrative codes, newspaper and magazine articles, public records, law journals, law reviews, treatises and legal forms.

The candidate data item database 132, in one embodiment, maintains the set of data items received by the communication module 126 and used by the scoring module 124 to analyze whether a candidate document should be on-boarded. The set of data items are derived from a candidate document and may include, but are not limited to, the candidate document type, level and jurisdiction of the court, identification of the parties, identification of the court officers, including the judge or judge and counsel for the parties, nature of the legal mater, and subject matter data, such as the legal concept at issue, damages data and fact pattern data. In one embodiment, the candidate data item database 132 maintains the set of data items in a structured data store, such as a relational or hierarchal database.

According to one embodiment, the set of predefined scoring patterns 136 includes one or more scoring rules used by the scoring module 124 to score individual data items and the candidate document itself and by the recommendation module 122 in order to make a determination as to whether to obtain or not obtain a candidate document. In one embodiment, the set of predefined scoring patterns 136 is maintained in a structured data store, such as a relational or hierarchal database, and is established by an administrator using the administrator device 190 to determine the scoring patterns to be utilized by the scoring module 124 in scoring individual data items.

Although the data store 130 shown in FIG. 1 is connected to the network 150, it will be appreciated by one skilled in the art that the data store 130 and/or any of the information shown therein, can be distributed across various servers and be accessible to the server 110 over the network 150; be coupled directly to the server 110; be configured as part of server 110 and interconnected to processor 112, RAM 114, the one or more input-output devices 116 and the non-volatile memory 120 via the common bus 118; or be configured in an area of non-volatile memory 120 of the server 110.

Content servers 170 and 180 are each configured to include a content server processor, RAM, one or more input-output devices, such as a display device and keyboard, and non-volatile memory, all of which are interconnected via a common bus and controlled by the respective content server processor. According to one embodiment, content servers 170 and 180 provide additional information to the scoring module 124 so that it can perform a subsequent analysis of the set of data items. In one embodiment the content server 170 may be a server that provides news content, such as global or national news, financial news, sporting event news or entertainment news. In another embodiment, the content server 180 may be a library of usage data regarding the activities of users of the on-line research system. In yet another embodiment, the content server 170 and 180 may publicly accessible databases making court documents available, such as New York State Unified Court System's e-Track website or the United States Supreme Court's website.

The access device 160, according to one embodiment, is a mobile device having a graphical user interface (“GUI”) 164, a digital signal processor 162, with an application module 162A, internal and external storage components (not shown), a power management system (not shown), an audio component (not shown), audio input/output components (not shown), an image capture and process system (not shown), RF antenna (not shown) and a subscriber identification module (SIM) (not shown). According to another embodiment, the access device 160, is a general purpose or special purpose computing device comprising a processor, transient and persistent storage devices, an input/output subsystem, a bus to provide a communications path between components comprising the general purpose or special purpose computer, and a web-based client application, such as a web browser, which allows a user to access the server 110 and the content servers 170 and 180. Examples of web browsers are known in the art, and include well-known web browsers such as such as Microsoft® Internet Explorer®, Google Chrome™, Mozilla Firefox® and Apple® Safari®.

The administrator device 190, according to one embodiment, is a general purpose or special purpose computing device comprising a processor, transient and persistent storage devices, an input/output subsystem, a bus to provide a communications path between components comprising the general purpose or special purpose computer, and a web-based client application, such as a web browser, which allows a user to access the server 110 and the content servers 170 and 180. Examples of web browsers are known in the art, and include well-known web browsers such as such as Microsoft® Internet Explorer®, Google Chrome™, Mozilla Firefox® and Apple® Safari®. According to another embodiment, administrator device 190 is a mobile device having a GUI (not shown), a digital signal processor with an application module (not shown), internal and external storage components (not shown), a power management system (not shown), an audio component (not shown), audio input/output components (not shown), an image capture and process system (not shown), RF antenna (not shown), and a subscriber identification module (SIM) (not shown).

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

Turning now to FIG. 2, an exemplary method 200 for on-boarding candidate documents to an on-line research system is disclosed. In the illustrated embodiment shown in FIG. 2, the communication module 126 receives a set of data items associated with a candidate document from the access device 160, step 210. As described previously, examples of a candidate document include, but are not limited, court documents, such as judicial decisions, orders and opinions, complaints, answers, briefs, legal memorandum, expert reports, deposition transcripts, trial transcripts, hearing transcripts and party contentions, as well as state and federal statutes, administrative codes, newspaper and magazine articles, public records, law journals, law reviews, treatises and legal forms. In one embodiment, the access device 160 is a mobile device in which a user sitting in a remote location, such as legal runner in a courthouse, uploads a set of data items associated with the candidate document located at the courthouse via the network 150 to the communication module 126 through the user interface 164. In another embodiment, the access device 160 is a general purpose computer from which a user monitors publicly accessible databases and uploads, via the network 150 to the communication module 126, a set of data items associated with a candidate document the user located in the one of the publicly accessible databases.

In one embodiment, the candidate document is a court document and the set of data items associated with the candidate document includes the candidate document type, level and jurisdiction of the court, identification of the parties, identification of the court officers, including the judge and/or counsel for the parties, and subject matter data, such as the legal concept at issue, damages data and fact pattern data. For example, the candidate document may be a complaint asserting a products liability cause of action filed in the Supreme Court of the State of New York and the set of data items includes: “doc type: first filed complaint,” “jurisdiction: Sate, N.Y., USA,” “court level: Supreme Court—Commercial Division,” “nature of suit: tort products liability,” “plaintiff(s): James Smithson, Anna Smithson” “defendant(s): ABC Paint Supplies” and “fact pattern data: allegation of ABC Prime X-1 paint causing retinal damage to husband, occupation painter” and “damages: compliant seeks $5 M US.” It is to be understood that the type of candidate document, as well as the number and type of data items are not limited to the description disclosed herein and that other candidate document types and data items may be provided.

According to one embodiment, the user interface 164, in order to receive the set of data items associated with a candidate document, provides a combination of vacant search fields configured to receive text inputs, e.g. a text box, and pre-defined fields, which include a plurality of pre-defined input values presented in a drop-down menu configuration. For example, the user interface 164 may provide a pre-defined field for the “doc type” that includes a drop down menu with a listing of pre-defined document type values, such as “complaint,” “answer” “answer and counter-claim(s)” from which the user may choose, while providing a vacant field for the defendant party data. In another embodiment, the user interface 164 provides only vacant search fields for a user to manually enter the set of data items associated with the candidate document. In another embodiment, the user interface 164, provides a combination of predefined and vacant input fields, which are a presented to a user in a prioritized sequence, so that the user may input data values in an iterative step process as additional information is needed.

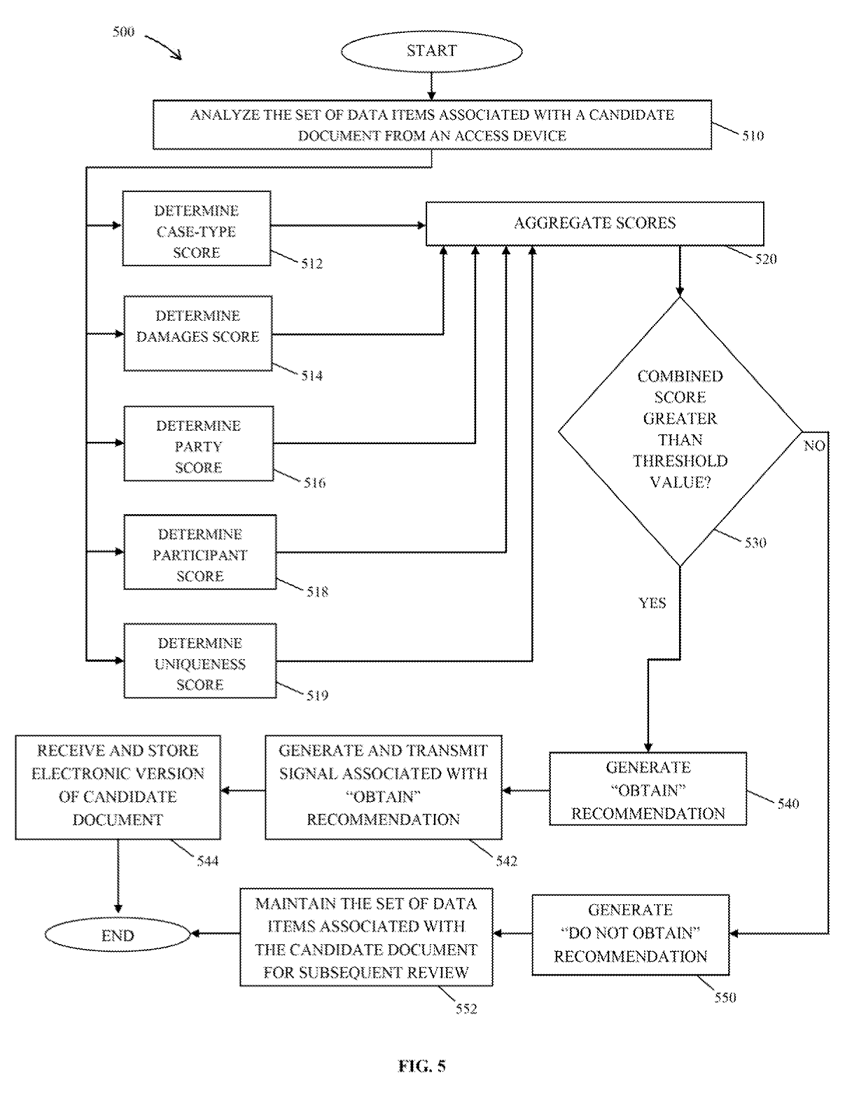

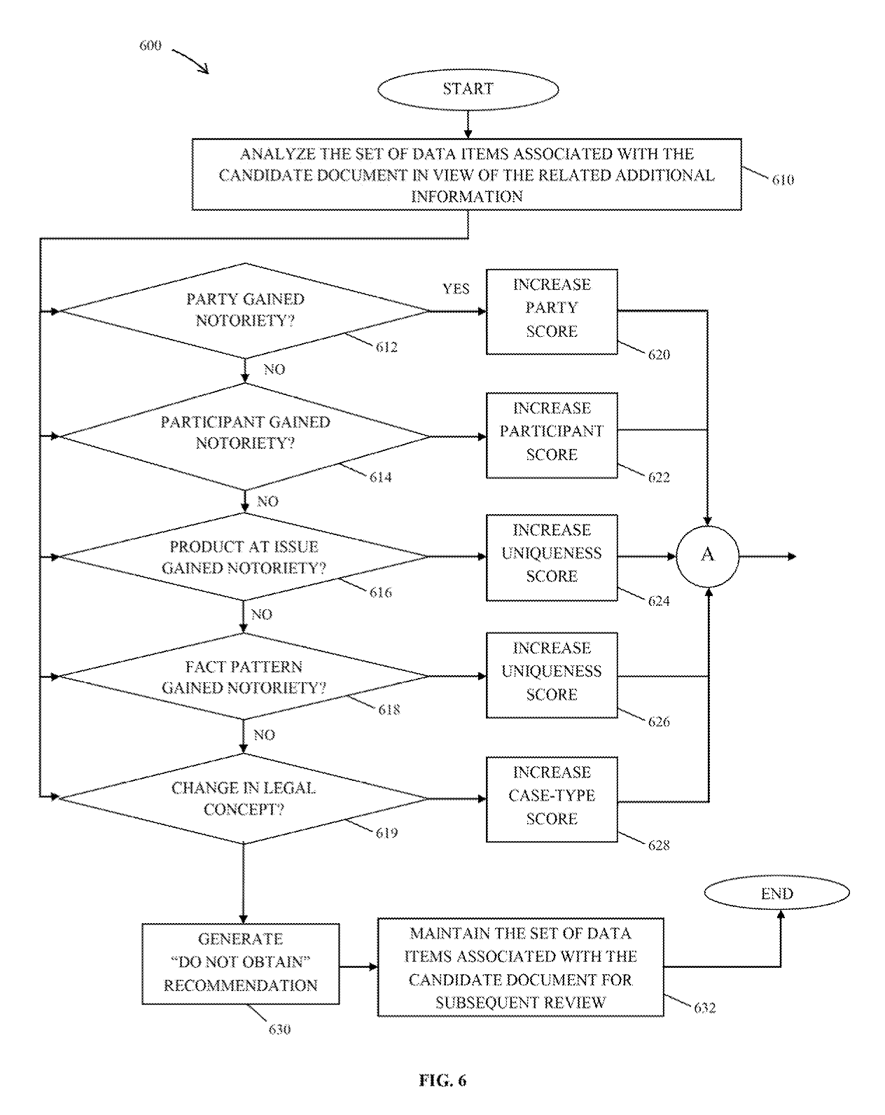

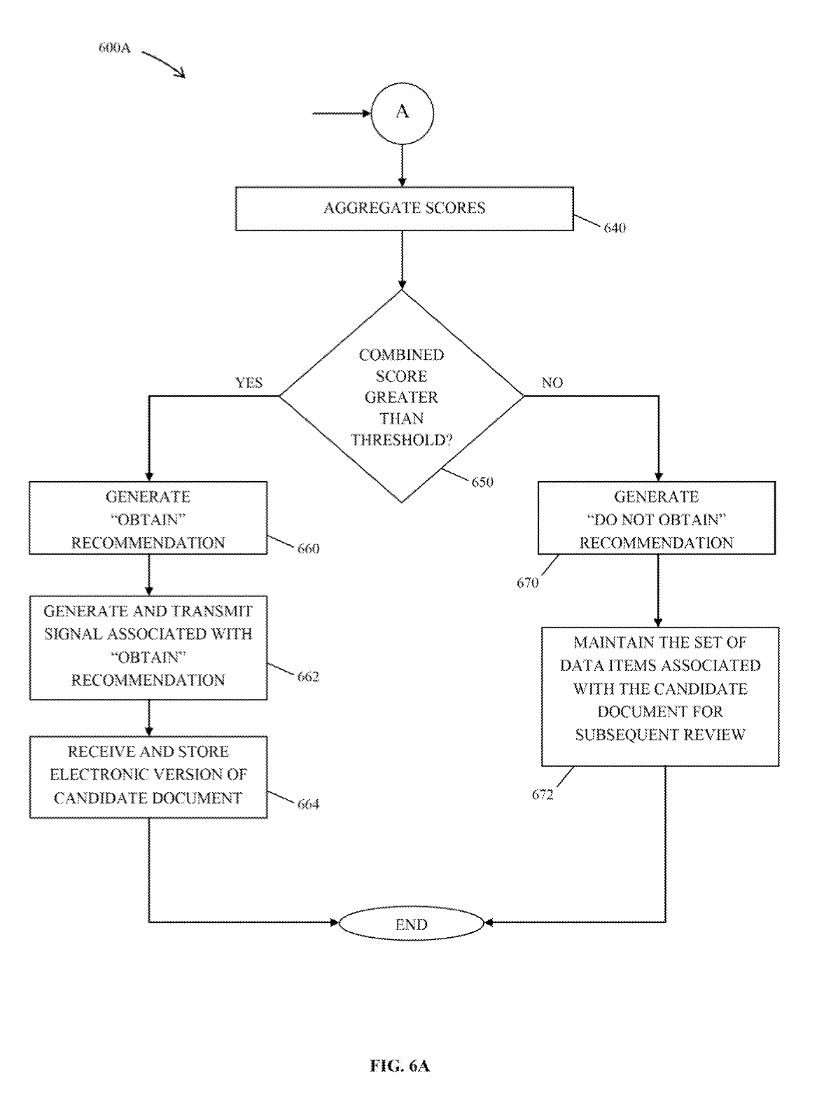

Returning to FIG. 2, in step 212, the set of data items is the stored in memory within the candidate data item database 132. According to one embodiment, the set of data items associated with the candidate document is stored and maintained in a structured document, such as an eXtensible Markup Language (XML) file. At step 214, according to one embodiment, the set of received data items are then automatically analyzed in order to determine a recommendation to obtain or not obtain the candidate document. In one embodiment, the scoring module 124 analyzes the set of received data items associated with the candidate document and determines individual scores for each of the data items in order to subsequently determine an overall score for the candidate document. Details regarding the specific scoring methodology are discussed in connection with FIGS. 5, 6 and 6A. The scoring module 124 makes its determination using the set of the pre-defined scoring patterns 136. In another embodiment, the scoring module 124 analyzes the set of received data items associated with the candidate document using a logic model.

In step 216, a recommendation is then generated by the recommendation module 122 to obtain or not obtain the candidate document. According to one embodiment, the recommendation module 122 receives an overall score for the candidate document and determines whether the candidate document should be presently obtained or not obtained by the system 100. The recommendation module 122 makes its determination to obtain or not obtain the candidate document based on whether the overall score of the document is greater than a threshold value. In another embodiment, the recommendation module 122 makes its determination based on the overall outcome of a logic model. According to another embodiment, at step 216, the recommendation module 122 first makes a determination as to whether that is has scores for sufficient number data items to make a recommendation and if not, generates a recommendation requesting additional data items.

In one embodiment, as depicted in step 218, once the recommendation is generated, the communication module 126 generates a signal associated with the recommendation. Lastly, at step 220, the communication module 126 transmits the generated signal to the access device 160. In one embodiment, the communication module 126 transmits the signal immediately upon completion of the generation of the signal.

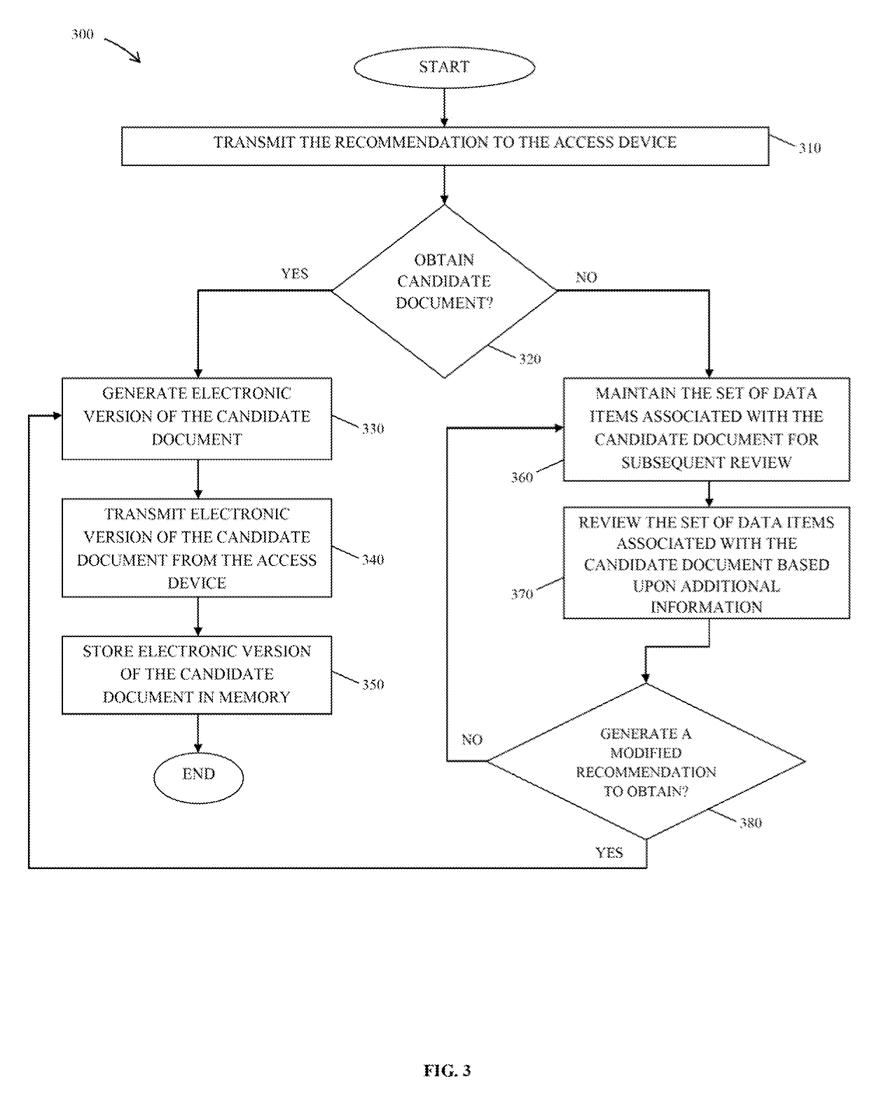

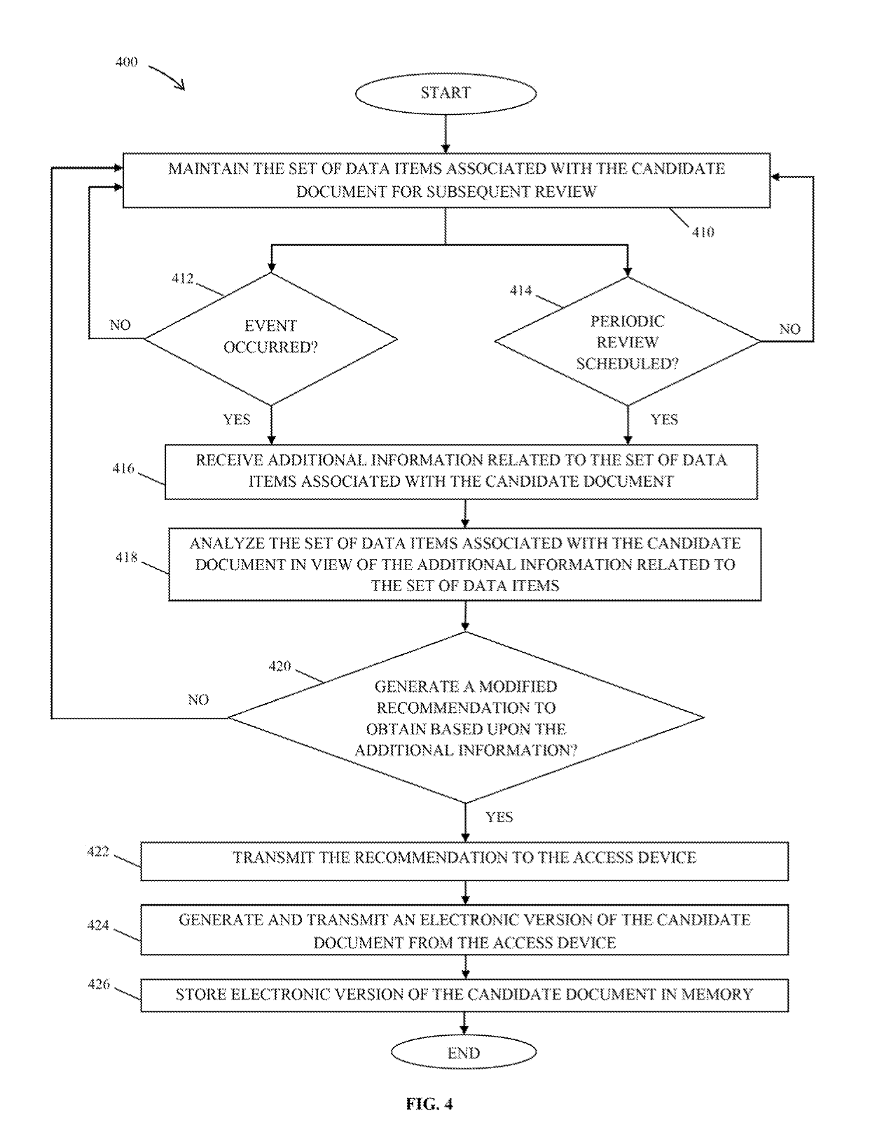

Turning now to FIG. 3, an exemplary computer-implemented method 300 for continuing to analyze candidate documents to determine whether they are to on-boarded to an on-line research system is disclosed. In step 310 of the embodiment shown in FIG. 3, the communication module 126 transmits the recommendation generated by the recommendation module 122 to the access device 160. According to one embodiment, the recommendation is one of two possibilities: (i) “Obtain Candidate Document” or (ii) “Do Not Obtain Candidate Document.” According to another embodiment, the recommendation is one of three possibilities: (i) “Obtain Candidate Document,” (ii) “Do Not Obtain Candidate Document” or (iii) “Supplemental Data Items Required,” along with a listing of the requisite supplemental data items. In the event that supplemental data items are requested, process flow will undergo method 200 and analyze the supplemental data items in conjunction the originally received in order to determine a recommendation to obtain or not obtain the document.

At step 320, a determination is made as to whether or not to obtain the candidate document. If the recommendation is to obtain the candidate document, process flow continues to step 330, in which an electronic version of the candidate document is generated. According to one embodiment, the user of the access device 160 receives the recommendation and undertakes the process of generating the electronic version of the document. In one embodiment, an electronic version the document is generated using techniques well-known in the art such as via use of a conventional paper scanner or a camera on a smartphone or tablet with a corresponding mobile application. Continuing with the previous example, in which the candidate document is a complaint asserting a products liability cause of action filed in the Supreme Court of the State of New York, a legal runner sitting in the courthouse, having received the recommendation on his mobile device to obtain the complaint, generates an electronic version of the complaint using a portable scanner connected to his mobile device.

In step 340, once the electronic version of the candidate document is generated, it is transmitted from the access device 160 to the communication module 126, step 340. Continuing with the previous example, the scanned electronic version of the complaint is uploaded over the network 150 from the legal runner's mobile device to the communication module 126. In step 350, the electronic version of the candidate document is then stored in memory within candidate document database 134.

Alternatively, at step 320, if the recommendation is to not obtain the candidate document, then the set of data items associated with the candidate document is maintained in the candidate data item database 132 for subsequent review as shown in step 360. At step 370, the set of data items associated with the candidate document are later analyzed in view of additional information related to the set of data items. According to one embodiment, additional information related to the set of data item includes an increase in notoriety for a given data item. For example, where one of the data items for a candidate court document is the identity of a defendant corporation, additional information discovered during a subsequent review would include the fact that the defendant corporation has filed documents with the Securities and Exchange Commission evidencing their intention to go public. Additional information related to the set of data items, in one embodiment, is obtained from content servers 170 and 180. For example content server 170 may be a financial newswire that provides headlines regarding financial events globally.

In one embodiment, the scoring module 124 analyzes the set of received data items associated with the candidate document in view of the related additional information and determines a modification, e.g. an increase or decrease, to each of the individual scores for each data item in order to subsequently determine an overall modified score for the candidate document. Details regarding the specific scoring methodology are discussed in connection with FIGS. 6 and 6A. The scoring module 124 makes its modified determination using the set of the pre-defined scoring patterns 136. In another embodiment, the scoring module 124 analyzes the set of received data items in view of the additional information using a logic model. Continuing with the previous example, the fact that the defendant corporation has filed documents with the Securities and Exchange Commission evidencing their intention to go public would alter and increase the score for the data item, “party identity,” which in turn alters and increases the overall score of the candidate court document. This is because there is typically a higher level of interest in public companies as opposed to privately held entities.

Returning to FIG. 3, at step 380, a determination is then made as to whether to generate a modified recommendation to obtain the candidate document. According to one embodiment, the recommendation module 122 receives a modified overall score for the candidate document and determines at this juncture whether the candidate document should be presently obtained or not obtained by the system 100. The recommendation module 122 makes its modified determination to obtain or not obtain the candidate document based on whether the overall score of the document is greater than a threshold value. Continuing with the previous example, the increase in the score for the data item, “party identity” in turn increased the overall score of the candidate court document, making the overall score greater than a threshold value and changing the recommendation from a “do not obtain candidate document” to an “obtain candidate document.”

If a modified recommendation is generated, then process flow returns to step 330, in which method 300 repeats the process of generating and transmitting an electronic version of the candidate document based on the modified recommendation. Conversely, if a determination is made to refrain from generating a modified recommendation to obtain the candidate document, process flow continues to step 360, in which the set of data items associated with the candidate document continue to be maintained in the candidate data item database 132 for subsequent review.

Turning now to FIG. 4, an exemplary computer-implemented method 400 for generating a modified recommendation to an on-line research system during a subsequent review is disclosed. In step 410 of the embodiment shown in FIG. 4, the set of data items associated with the candidate document is maintained in the candidate data item database 132 for subsequent review, step 410.

The subsequent review is initiated by a triggering occurrence, such as the occurrence of an event or a scheduled periodic review. According to one embodiment, a scheduled periodic review is a subsequent review to occur on a periodic basis, such as annually, monthly, weekly, or daily. The defined periodic review rules, such as the frequency of the subsequent review, are maintained in the set of pre-defined scoring patterns 136. In one embodiment, an administrator, using the administrator device 190, defines the rules for the periodic review and has the ability to modify the periodic review rules to alter the frequency of the subsequent review as desired.

According to one embodiment, an event, as disclosed herein, is a significant occurrence relating to one or more of the data items associated with the candidate document, such as a national news event, financial news event, sporting news event, legal news event and/or a legal concept event. For example, where the data item for a candidate document is the identity of the plaintiff husband and wife, and an event would be a widespread news report that the plaintiff husband has been romantically involved with a famous Hollywood actress.

In one embodiment, the occurrence of an event is defined by a set of rules maintained within the set of pre-defined scoring patterns 136. A rule may be to obtain the candidate document if the number of times a data item appears in a news story is higher than a threshold value. For example, if a rule is that a judge's identity appears in more than five thousand news articles, where a judge is nominated to the United States Supreme Court and hence here name appears in more approximately twelve thousand news articles, the nomination would be defined as an event since the data item, in this example the judge's name, appeared in more than five thousand news articles.

Another rule might be to obtain the candidate document if the data item is related to a change in a legal concept. In another example, where the data item is the nature of the suit, in this example fair labor standards act, a ruling by the United States Supreme Court regarding the definition of “principals activities” under the Fair Labor Standards Act is defined as an event as it involves a major ruling regarding the Fair Labor Standards Act by the Supreme Court. In another example, the occurrence of an event may constitute a rule set up by an administrator at the administrator device 190 based on usage data from an on-line research system, such as the data usage demonstrating that in the last year, users of the on-line research system have searched for three times more bankruptcy cases than in the previous two years.

In one embodiment, information regarding events is received from content servers 170 and 180. For example, content server 170 may be a newswire that provides a variety of headlines, such as headlines related to scandals in the entertainment industry or the website of the United States Supreme Court posting their most recent decisions. Content server 180 may, for example, comprise a library of usage data regarding the activities of users with an on-line research system.

Returning to FIG. 4, in step 412, a determination is made as to whether an event occurred. In one embodiment, the scoring module 124 identifies the occurrence of an event based on the rules maintained in the set of pre-defined scoring patterns 136. For example, the scoring module 124 determines an event occurrence of a party's name appearing in the news more than a threshold value from the content server 170, which maintains such information from the newswire feed. If an event has not occurred, then process flow returns to step 410 and the set of data items continue to be maintained in the candidate data item database 132. Alternatively, in step 414, a determination is made as to whether a periodic review is scheduled. For example, scoring module 124 determines whether it been three months since the last periodic review or since the “do not obtain” recommendation was first transmitted based on information maintained in the set of pre-defined scoring patterns 136. If the scheduled time has not occurred, then process flow returns to step 410 and the set of data items continue to be maintained in the candidate data item database 132.

If, however, an event or the scheduled time for the periodic review has occurred, then process flow continues to step 416, in which additional information related to the set of data items associated with the candidate document is received. As disclosed previously, according to one embodiment, additional information related to the set of data item includes an increase in notoriety for a given data item. For example, the fact that a defendant corporation has filed documents with the Securities and Exchange Commission evidencing their intention to go public. At step 418, the set of data items associated with the candidate document is then analyzed in view of the additional information related to the set of data items. As disclosed previously, in one embodiment, the scoring module 124 having analyzed the set of received data items in view of the related additional information, makes a determination as to whether the individual scores for each data item should be increased or decreased, in order to subsequently determine an overall modified score for the candidate document.

In step 420, a determination is then made as whether to generate a modified recommendation to obtain the candidate document based upon the additional information. According to one embodiment, the recommendation module 122 receives a modified overall score for the candidate document and determines at this juncture whether the candidate document should be presently obtained or not obtained by the system 100. The recommendation module 122 makes its modified determination to obtain or not obtain the candidate document based on whether the overall score of the document is greater than a threshold value. If a determination is made to refrain from generating a modified “obtain” recommendation, the process flow returns to step 410, in which the set of data items associated with the candidate document is then maintained in the candidate data item database 132 for subsequent review.

Otherwise, if a modified recommendation is generated to obtain the candidate document, then process flow continues to step 422 and the modified recommendation is transmitted to the access device 160. Subsequently, at step 424, an electronic version of the candidate document is generated and transmitted from the access device 160 to the communication module 126. At step 426, the electronic version of the candidate document is stored in memory within the candidate document database 134.

Turning now to FIG. 5, a further detailed exemplary computer-implemented method 500 for generating a recommendation to on-board a candidate document to an on-line research system is disclosed. In the illustrated embodiment shown in FIG. 5, the scoring module 124 analyzes the set of data items associated with a candidate document from the access device 160, step 510. In steps 512 though 519, a series of scores is then determined for the candidate document from the set of associated data items. According to one embodiment, a case-type score, a damages score, a party score, a participant score and a uniqueness score are determined for the candidate document by the scoring module 124, via steps 512-519, based on a plurality of defined rules maintained in the set of pre-defined patterns 136.

A case-type score is a score assigned to the candidate document based on the data item for the nature of the suit within the court document. For example, the set of pre-defined patterns 136 may include a set of defined rules that sets forth that all intellectual property suits, professional negligence suits, class action suits, medical malpractice suits, and products liability suits are to be assigned a case-type score of 3; all fraud, breach of contract, bankruptcy and employment discrimination suits are to receive a score of 2; and all divorce, premises liability and motor vehicle suits are to receive a score of 1.

A party score is a score assigned to the candidate document based on the data item for the identification of the party in the court document. For example, the set of pre-defined patterns 136 may include a set of defined rules that dictates that any party that is a Fortune 100 company or a specific government agency, such as the Securities and Exchange Commission or the United States Attorney General's office, receives a score of 3; any state government, Fortune 500 company, publicly traded company or individual with celebrity status receives a score of 2; and any private individual or small privately held company receives a score of 1.

A participant score is a score assigned to the candidate document based on the data item for the identification of the any participants in the court document, such as the judge, counsel, a party's counsel, or a party's counsel's law firm. For example, the set of pre-defined patterns 136 may include a set of defined rules that mandates that any large law firm, e.g. more than 500 attorneys, receives a score of 3; any medium-sized law firm receives a score of 2; and any small firm or solo practitioner receives a score of 1. A damages score is a score assigned to the candidate document based on the damages awarded or sought in the court document. For example, the set of pre-defined patterns 136 may include a set of defined rules that cases wherein damages sought or awarded are in excess of US $10 Million are to receive a score of 3, cases wherein damages awarded or sought are between US $1 Million and US $10 Million are to receive a score of 2, any cases wherein any damages awarded or sought are less than US $1 Million are to receive a score of 1.

A uniqueness score is a score assigned to the candidate document based on the data items associated with the fact pattern of the candidate document. For example, a uniqueness score may be based on the products at issue, the legal concept at issue or the geographic location at issue. The set of pre-defined patterns 136 may include a set of defined rules that sets forth that varying numerical score values from 1 to 3 for these individual characteristics. For example, if the candidate document involves a pharmaceutical drug, the uniqueness score is scored higher than a court document pertaining to a malfunctioning appliance. Similarly, if the candidate document relates to a hotly contested legal concept, such as a criminal case involving the accidental discharge of a firearm by a minor, which touches on gun control, the uniqueness score is scored higher than a court document pertaining to an assault and battery incident having taken place at a night club without the use of weapons.

It is to be understood that the number and types of scores determined for a candidate document are not limited to the number and types of scores described herein, which are being disclosed solely to serve as exemplary score types, and that other score types may be determined from the set of data items associated with the candidate document by the scoring module 124. Further, the examples of each of the score types disclosed herein are presented purely for illustrative purposes and are not intended to limit the exemplary score disclosed herein. Additionally, it is important to note that the scoring scale is not limited to a 1 to 3 numerical scale, but can utilize any variation of a scoring scale, as well any other methods known in the art for scoring.

Returning to FIG. 5, the scores are then aggregated at step 520 by the scoring module 124. In one embodiment, the individual scores are aggregated by adding each of the individual scores. For example, the case-type score, the damages score, the party score, the participant score and the uniqueness score would be added with the total sum being the overall score for the candidate complaint document. In another embodiment, the individual scores are aggregated using a weighted sum model. For example, using a weighted sum model, the case-type score, the damages score and the party score would be weighted higher than the participant score and the uniqueness score in determining the overall score of the candidate document.

Next, at step 530, a determination is made by the recommendation module 122 as to whether the combined score is greater than a threshold value. In one embodiment, the set of pre-defined patterns 136 includes a defined rule that sets forth the overall threshold numerical score that is to be used by the recommendation module 122 to generate an “obtain” or a “do not obtain” recommendation. For example, where the candidate document is a complaint asserting a products liability cause of action and the set of data items includes “nature of suit: tort products liability” being assigned a case-type score of 3; “plaintiff(s): James Smithson, Anna Smithson” and “defendant(s): ABC Paint Supplies” being assigned a party score of 1; “damages: compliant seeks $5 M US” being assigned a damages score of 2 and “fact pattern data: allegation of ABC Prime X-1 paint causing retinal damage to husband, occupation painter” being assigned a uniqueness score of 1, an overall score would be the sum total of the individual scores, in this example, an overall score of 7. Further, the threshold value to obtain a document may be defined within the set of pre-defined patterns 136 may be 8, in which case the recommendation module 122 would determine that the candidate document should not be obtained

If the combined score is greater than the threshold value, an “obtain” recommendation is generated at step 540 and process flow then continues to step 542, in which a signal associated with the “obtain” recommendation is generated and transmitted by the communication module 126 to the access device 160. Subsequently, at step 544, an electronic version of the candidate document is generated and received from the access device 160 and stored in the on-boarded document database 134 and the process flow ends. It should be noted that once an “obtain” recommendation is generated and the candidate document is ultimately obtained and stored, the set of data items associated with the candidate document also continues to be maintained in the candidate item database 132 for subsequent analysis.

Returning to FIG. 5, if the combined score is less than the threshold value, a “Do Not Obtain” recommendation is generated at step 550 and process flow then continues to step 552, in which the set of data items associated with the candidate document continue to be maintained in candidate item database 132.

Turning now to FIGS. 6 and 6A, a further detailed exemplary computer-implemented method for generating a modified recommendation to an on-line research system during a subsequent review is disclosed. In step 610 of the embodiment shown in FIG. 6, the scoring module 124 analyzes the set of data items associated with the candidate document in view of the additional information received from the content servers 170 and 180. For example, content server 170 may be a newswire that provides a variety of headlines, such as headlines related to scandals in the entertainment industry or the website of the United States Supreme Court posting their most recent decisions. Content server 180 may, for example, a library of usage data regarding the activities of users with an on-line research system.

Individual data items from the set of data items associated with the candidate document are then analyzed based upon the received additional information. According to one embodiment, as shown via decision boxes 612-619, the individual data items analyzed include the party data, court officer data, product data, fact pattern data and legal concept data in order to determine whether there has been any change to the set of data items.

In one embodiment, at step 612, in the instance where the candidate document is a judicial order, a determination is made as to whether any of the parties in the candidate document has gained notoriety. An example of this would be when the plaintiff or defendant to the legal proceeding in the candidate document has gained popularity in the news. For example, in a divorce proceeding between plaintiff wife and defendant ex-husband, it is determined that the plaintiff wife has gained notoriety because she had later become hugely popular as an A-list Hollywood actress. If a determination is made that the party has gained notoriety, the party score is increased at step 620. Continuing with the previous example, the party score for the plaintiff wife in the divorce decree increased from a score of 1 to 3 because she has become a popular Hollywood actress often mentioned in the news.

Similarly, at step 614, a determination is made as to whether any of the participants from the candidate document has gained notoriety. This may occur when the judge, counsel, counsel's firms, experts or relevant third-parties have gained notoriety. Examples of participants gaining notoriety include where a judge is elevated to a higher court or decides to abandon his judicial career to pursue a political career, or a pharmaceutical manufacturer involved in a products liability action files documents with the Securities and Exchange Commission to become a publicly traded company. If a determination is made that the participant has gained notoriety, the participant score is increased at step 622.

At step 616, a determination is made as to whether the product at issue from the candidate document has gained notoriety. One example of a product gaining notoriety is where the candidate document pertains to a products liability case involving a defective tire, and later a series of class action suits are filed involving the defective tire. If a determination is made that the product at issue has gained notoriety, the uniqueness score is increased at step 624. Similarly, at step 618, a determination is made as to whether the fact pattern from the candidate document has gained notoriety. On example of a fact pattern gaining notoriety is in a civil suit charged against a military organization for its use of interrogation tactics and the military's use of interrogation techniques are later displayed in a documentary that receives world-wide attention stirring a global debate. If a determination is made that the fact pattern has gained notoriety, the uniqueness score is increased at step 626.

At step 619, a determination is made as to whether there was change in legal concept discussed in the candidate document. For example, the candidate documents pertain to a court's decision on divided patent infringement and later the United States Supreme Court reverses the country's long standing doctrine on what is required to prove divided infringement. If a determination is made that the legal concept has changed, the case-type score is increased at step 628.

Turning now to FIG. 6A, if any of the scores have been modified, e.g. increased because of a change in notoriety for the individual data items, the scoring module 124 aggregates the individual scores, including any increased scores at step 640. As disclosed previously, the scores are aggregated by summing the individual scores according to one embodiment. In another embodiment, the scores are aggregated using a weighted sum mode. Next, at step 650, a determination is made by the recommendation module 122 as to whether the combined score is greater than the threshold value. In one embodiment, the set of pre-defined patterns 136 includes a defined rule that sets forth the overall threshold numerical score that continues to be used by the recommendation module 122 to generate a modified “obtain” or a “do not obtain” recommendation. For example, where the candidate document is a complaint asserting a products liability cause of action for defective paint and the set of data items includes the identity of the plaintiff who has since been charged as a serial murder and is claiming an insanity, the party score would be increased because of the increase in notoriety of the plaintiff, and the uniqueness score would increase as well because its alleged in his defense that the insanity was caused by the use of the defective paint, having thereby increased the notoriety of the product at issue in the candidate document. Continuing in this example, the uniqueness score and party score would each be increased to a score of 3, modifying the overall score of the candidate document to an 11, which would be then compared to threshold value of 8 maintained in the set of pre-defined scoring patterns 136.

If the combined score is greater than the threshold value, an “obtain” recommendation is generated at step 660 and process flow then continues to step 662, in which a signal associated with the “obtain” recommendation is generated and transmitted by the communication module 126 to the access device 160. Subsequently, at step 664, an electronic version of the candidate document is generated and received from the access device 160 and stored in the on-boarded document database 134. Alternatively, if the combined score is less than the threshold value, a “do not obtain” recommendation is generated at step 670 and process flow then continues to step 672, in which the set of data items associated with the candidate document continue to be maintained in candidate item database 132.

Returning now to FIG. 6, if there has not been any change to the set of data items, e.g. none of the parties, participants, products, fact patterns or legal concepts have changed, then process flow continues to step 630, in which a “do not obtain” recommendation is generated and then the set of data items associated with the candidate document continue to be maintained in candidate item database 132 via step 632.

It is to be understood that the number and types of data items analyzed and scores determined for a candidate document in this disclosed subsequent review are not limited to the number and types of scores described herein, which are being disclosed herein as exemplary, and that other data items may be analyzed and other score types may be determined from the set of data items associated with the candidate document by the scoring module 124.

FIGS. 1 through 6A are conceptual illustrations allowing for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not as limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for recommending the on-boarding of candidate documents to an on-line research system, the computer-implemented method comprising:
receiving, from an electronic device, a set of data items associated with a candidate document, the candidate document being a document that is a candidate to be made available via the on-line research system;
storing the set of data items in a first memory;
automatically analyzing the set of data items using a computer program stored in the first memory;
generating, using the computer program, a recommendation as to whether to obtain or not obtain the candidate document; and
generating a signal based upon the recommendation; and
transmitting the signal to the electronic device.

2. The computer-implemented method of claim 1, wherein automatically analyzing the set of data items using a computer program stored in the first memory further comprises:
determining a score for each of one or more data items from the set of data items according to one or more pre-defined scoring patterns; and
aggregating the one or more scores for the one or more data items in order to calculate an overall score for the candidate document.

3. The computer-implemented method of claim 2, wherein generating, using the computer program, a recommendation as to whether to obtain or not obtain the candidate document further comprises:
determining that the overall score for the candidate document is equal to or greater than a threshold value, the threshold value being defined by the one or more pre-defined scoring patterns; and
generating a recommendation to obtain the candidate document.

4. The computer-implemented method of claim 2, wherein generating, using the computer program, a recommendation as to whether to obtain or not obtain the candidate document further comprises:
determining that the overall score for the candidate document is less than a threshold value, the threshold value being defined by the one or more pre-defined scoring patterns; and
generating a recommendation to not obtain the candidate document.

5. The computer-implemented method of claim 1 further comprising:
in response to the step of transmitting the signal and wherein the recommendation is an obtain recommendation, receiving an electronic version of the candidate document from the electronic device; and
storing the electronic version in a second memory.

6. The computer-implemented method of claim 1 further comprising:
in response to the step of transmitting the recommendation and wherein the recommendation is a do not obtain recommendation, reviewing the set of data items based upon a set of additional information; and
based upon the step of reviewing, determining whether to generate a modified recommendation and, if a modified recommendation is generated:
storing the modified recommendation in the first memory;
generating a modified signal based upon the modified recommendation; and
transmitting the modified signal to the electronic device.

7. The computer-implemented method of claim 6, wherein the step of reviewing is ongoing and is triggered by at least one of:
an event; and
an end of a time period since the last time the step of reviewing was performed.

8. The computer-implemented method of claim 7, wherein the time period is selected from a day, a week, a month, and a year.

9. The computer-implemented method of claim 7, wherein the event comprises one or more of a national news event, financial news event, sporting news event, legal news event and a legal concept event.

10. The method of claim 6 further comprising:
in response to the step of transmitting the modified signal and wherein the modified recommendation is an obtain recommendation, receiving an electronic version of the candidate document from the electronic device; and
storing the electronic version in the second memory.

11. The computer-implemented method of claim 6, wherein reviewing the set of data items based upon a set of additional information further comprises:
determining a modified score for each of one or more data items from the set of data items according to one or more pre-defined scoring patterns based upon the set of additional information; and
aggregating the one or more modified scores for the one or more data items in order to calculate a modified overall score for the candidate document.

12. The computer-implemented method of claim 6, wherein determining whether to generate a modified recommendation further comprises:
determining that the modified overall score for the candidate document is equal to or greater than a modified threshold value, the modified threshold value being defined by the one or more pre-defined scoring patterns; and
generating a modified recommendation to obtain the candidate document.

13. The computer-implemented method of claim 6, wherein determining whether to generate a modified recommendation further comprises:
determining that the modified overall score for the candidate document is less than a modified threshold value, the modified threshold value being defined by the one or more pre-defined scoring patterns; and
generating a modified recommendation to not obtain the candidate document

14. The computer-implemented method of claim 6, wherein the set of additional information comprises information identifying any increase in notoriety to a given data item from the set of data items.

15. The computer-implemented method of claim 1, wherein the electronic device is a mobile device.

16. Non-transitory computer readable media comprising program code stored thereon for execution by a programmable processor to perform a method for recommending the on-boarding of candidate documents to an on-line research system, the computer readable media comprising:
program code for receiving, from an electronic device, a set of data items associated with a candidate document, the candidate document being a document that is a candidate to be made available via the on-line research system;
program code for storing the set of data items in a first memory;
program code for automatically analyzing the set of data items using a computer program stored in the first memory;
program code for generating a recommendation as to whether to obtain or not obtain the candidate document; and
program code for generating a signal based upon the recommendation; and
program code for transmitting the signal to the electronic device.

17. The computer readable media of claim 16, wherein program code for automatically analyzing the set of data items using a computer program stored in the first memory further comprises:
program code for determining a score for each of one or more data items from the set of data items according to one or more pre-defined scoring patterns; and
program code for aggregating the one or more scores for the one or more data items in order to calculate an overall score for the candidate document.

18. The computer readable media of claim 16, wherein the program code for generating a recommendation as to whether to obtain or not obtain the candidate document further comprises:
program code determining that the overall score for the candidate document is equal to or greater than a threshold value, the threshold value being defined by the one or more pre-defined scoring patterns; and
program code generating a recommendation to obtain the candidate document.

19. The computer readable media of claim 17, wherein the program code for generating a recommendation as to whether to obtain or not obtain the candidate document further comprises:
program code for determining that the overall score for the candidate document is less than a threshold value, the threshold value being defined by the one or more pre-defined scoring patterns; and
program code for generating a recommendation to not obtain the candidate document.

20. The computer readable media of claim 16 further comprising:
in response to the execution of the program code for transmitting the signal and wherein the recommendation is an obtain recommendation, program code for receiving an electronic version of the candidate document from the electronic device; and
program code for storing the electronic version in a second memory.

21. The computer readable media of claim 16 further comprising:
in response to the execution of the program code for transmitting the recommendation and wherein the recommendation is a do not obtain recommendation, program code for reviewing the set of data items based upon a set of additional information; and
based upon the execution of the program code for reviewing, program code for determining whether to generate a modified recommendation and, if a modified recommendation is generated:
program code storing the modified recommendation in the memory;
program code generating a modified signal based upon the modified recommendation; and
program code transmitting the modified signal to the electronic device.

22. The computer readable media of claim 21, wherein the execution of program code for reviewing is ongoing and is triggered by at least one of:
an event; and
an end of a time period since the last time the step of reviewing was performed.

23. The computer readable media of claim 22, wherein the time period is selected from a day, a week, a month, and a year.

24. The computer readable media of claim 22, wherein the event comprises one or more of a national news event, financial news event, sporting news event, legal news event and a legal concept event.

25. The computer readable media of claim 21 further comprising:
in response to the execution of program code for transmitting the modified signal and wherein the modified recommendation is an obtain recommendation, program code for receiving an electronic version of the candidate document from the electronic device; and
program code for storing the electronic version in the second memory.

26. The computer readable media of claim 21, wherein program code for reviewing the set of data items based upon a set of additional information further comprises:
program code for determining a modified score for each of one or more data items from the set of data items according to one or more pre-defined scoring patterns based upon the set of additional information; and
program code for aggregating the one or more modified scores for the one or more data items in order to calculate a modified overall score for the candidate document.

27. The computer readable media of claim 21, wherein program code for determining whether to generate a modified recommendation further comprises:
program code for determining that the modified overall score for the candidate document is equal to or greater than a modified threshold value, the modified threshold value being defined by the one or more pre-defined scoring patterns; and
program code for generating a modified recommendation to obtain the candidate document.

28. The computer readable media of claim 21, wherein program code for determining whether to generate a modified recommendation further comprises:
program code for determining that the modified overall score for the candidate document is less than a modified threshold value, the modified threshold value being defined by the one or more pre-defined scoring patterns; and
program code for generating a modified recommendation to not obtain the candidate document

29. The computer readable media of claim 21, wherein the set of additional information comprises information identifying any increase in notoriety to a given data item from the set of data items.

30. The computer readable media of claim 21, wherein the electronic device is a mobile device.

31. A system for recommending the on-boarding of candidate documents to an on-line research system, the system comprising:
a data repository comprising a first memory and a second memory; and
a server including a processor configured to:
receive, from an electronic device, a set of data items associated with a candidate document, the candidate document being a document that is a candidate to be made available via the on-line research system;
store the set of data items in the first memory;
automatically analyze the set of data items using a computer program stored in the first memory;
generate, using the computer program, a recommendation as to whether to obtain or not obtain the candidate document; and
generate a signal based upon the recommendation; and
transmit the signal to the electronic device.

32. The system of claim 31, wherein the server, in automatically analyzing the set of data items using a computer program stored in the first memory, is further configured to:
determine a score for each of one or more data items from the set of data items according to one or more pre-defined scoring patterns; and
aggregate the one or more scores for the one or more data items in order to calculate an overall score for the candidate document.

33. The system of claim 32, wherein the server, in generating a recommendation as to whether to obtain or not obtain the candidate document, is further configured to:
determine that the overall score for the candidate document is equal to or greater than a threshold value, the threshold value being defined by the one or more pre-defined scoring patterns; and
generate a recommendation to obtain the candidate document.

34. The system of claim 32, wherein the server, in generating a recommendation as to whether to obtain or not obtain the candidate document, is further configured to:
determine that the overall score for the candidate document is less than a threshold value, the threshold value being defined by the one or more pre-defined scoring patterns; and
generate a recommendation to not obtain the candidate document.

35. The system of claim 31, wherein the server is further configured to:
in response to the step of transmitting the signal and wherein the recommendation is an obtain recommendation, receive an electronic version of the candidate document from the electronic device; and
store the electronic version in a second memory.

36. The system of claim 31, wherein the server is further configured to:
in response to the step of transmitting the recommendation and wherein the recommendation is a do not obtain recommendation, review the set of data items based upon a set of additional information; and
based upon the step of reviewing, determine whether to generate a modified recommendation and, if a modified recommendation is generated:
store the modified recommendation in the first memory;
generate a modified signal based upon the modified recommendation; and
transmit the modified signal to the electronic device.

37. The system of claim 36, wherein the reviewing step performed by the server is ongoing and is triggered by at least one of:
an event; and
an end of a time period since the last time the step of reviewing was performed.

38. The system of claim 37, wherein the time period is selected from a day, a week, a month, and a year.

39. The system of claim 37, wherein the event comprises one or more of a national news event, financial news event, sporting news event, legal news event and a legal concept event.

40. The system of claim 36, wherein the server is further configured to:
in response to the step of transmitting the modified signal and wherein the modified recommendation is an obtain recommendation, receive an electronic version of the candidate document from the electronic device; and
store the electronic version in the second memory.

41. The system of claim 36, wherein the server in reviewing the set of data items based upon a set of additional information, is further configured to:
determine a modified score for each of one or more data items from the set of data items according to one or more pre-defined scoring patterns based upon the set of additional information; and
aggregate the one or more modified scores for the one or more data items in order to calculate a modified overall score for the candidate document.

42. The system of claim 36, wherein the server in determining whether to generate a modified recommendation, is further configured to:
determine that the modified overall score for the candidate document is equal to or greater than a modified threshold value, the modified threshold value being defined by the one or more pre-defined scoring patterns; and
generate a modified recommendation to obtain the candidate document.

43. The system of claim 36, wherein the server in determining whether to generate a modified recommendation, is further configured to:
determine that the modified overall score for the candidate document is less than a modified threshold value, the modified threshold value being defined by the one or more pre-defined scoring patterns; and
generate a modified recommendation to not obtain the candidate document

44. The system of claim 36, wherein the set of additional information comprises information identifying any increase in notoriety to a given data item from the set of data items.

45. The system of claim 31, wherein the electronic device is a mobile device.
